(19) United States
(12) Patent Application Publication
(10) Pub. No.: US 2010/0031072 A1
(43) Pub. Date: Feb. 4, 2010

(54) SYSTEM FOR POWER MANAGEMENT AND SAFETY PROTECTION AND METHOD THEREOF

(75) Inventors: Shih-Che HUNG, Hsinchu City (TW); Jian-Ji CHEN, Pingjhen City (TW); Hung-Lun LIU, Ji-an Township (TW)

Correspondence Address: Workman Nydegger;1000 Eagle Gate Tower, 60 East South Temple, Salt Lake City, UT, 84111, US

(73) Assignee: MICRO-STAR INTERNATIONAL CO., LTD., Jung-He City (TW)

(21) Appl. No.: 12/237,553

(22) Filed: Sep. 25, 2008

(30) Foreign Application Priority Data
Jul. 30, 2008 (TW) 097128913

(51) Int. Cl. G06F 1/00

(52) U.S. Cl. 713/323

(57) ABSTRACT

A system for power management and safety protection and a method thereof are presented. The system and method are applicable to a computer device having a sensor. The sensor detects position information of a user relative to the computer device so as to determine whether to enter a sleep mode or a recognition mode. The sensor also detects motion information of a particular motion of the user so as to return to an operating mode.

### CROSS-REFERENCE TO RELATED APPLICATIONS

This non-provisional application claims priority under 35 U.S.C. §119(a) on Patent Application No(s). 097128913 filed in Taiwan, R.O.C. on Jul. 30, 2008 the entire contents of which are hereby incorporated by reference.

### BACKGROUND OF THE INVENTION

1. Field of Invention

The present invention relates to a method for power management and safety protection and a system using the same, and more particularly, to a method for managing power by an ultrasonic sensor.

2. Related Art

An advanced configuration and power interface (ACPI) integrates power performance management, temperature monitoring, and battery power management of and between an operating system, peripheral devices, a central processing unit, various embedded microcontrollers, and buses in a computer system. Integration of the operating system, the central processing unit, and the peripheral devices for exchanging messages of power usage with one another allows an easier and more effective joint management of the power.

In short, the ACPI may manage the power supply according to whether the user operates the computer system. For example, if the user departs from the computer system, devices such as a display or a storage device of the computer system will be turned off after no operations are performed by the computer system via peripheral devices such as a mouse and a keyboard in a preset period of time. That is to say, the computer system enters a sleep mode to reduce the power consumption thereof. When the user comes back to the computer system again and operates the peripheral devices such as the mouse and the keyboard, the computer system is awaken and turns on the devices such as the display or the storage device, and the computer system thus returns to an operating mode.

The power management mode of the computer system described above surely can enter the sleep mode to reduce the power consumption in the case that the computer system is not used in a preset period of time. However, this is not the best power-saving design, since the power is continuously consumed during the period of time from the departure of the user to the entry of the sleep mode although the user does not use the computer system. Moreover, after the user departs, other people may come and operate the computer system so as to enable the computer system to return to the operating mode from the sleep mode. In this manner, relevant information of the computer system may be stolen, and a safety protection mechanism cannot be provided.

In order to solve the above problems, U.S. Pat. No. 7,196,720 disclosed a method and an apparatus for powering on an electronic device with a video camera that detects motion. In this patent, a video camera is connected to an electronic device such that when the electronic device is in the sleep mode, the electronic device is powered on from the sleep mode or other power-saving states when the video camera detects a motion.

In addition, U.S. Pat. No. 6,418,536 disclosed a power-saving portable computer using a user sensing device. In this patent, a sensing device having a user-detection function is provided such that a power-saving function is immediately turned on when a user departs from the computer.

In the above patents, the video camera or the sensing device enables the computer system to obtain real-time states of the user such as departing or approaching the computer system, thereby surely achieving the power-saving purpose. For safety protection, a password management technology is generally employed. That is to say, when the user approaches the computer system, the computer system activates a password entry box. The user must use the keyboard to input a preset password in order to enable the computer system to enter the operating mode. Therefore, the computer system must maintain power supplies of the video camera, sensing device, and the keyboard at the same time. Alternatively, since the computer system is equipped with the video camera, images captured by the video camera may be used to perform a face recognition technology for the purpose of safety protection. However, the face recognition technology is quite complex. Therefore, there is a need for improving the power management and the safety protection of the computer system.

### SUMMARY OF THE INVENTION

For a conventional computer system, in view of power management and safety protection, although real-time states of a user may be obtained by a video camera or a sensing device to achieve a real-time power-saving control, a password management technology or a face recognition technology has to be used for the purpose of safety protection, which results in complexity of the computer system. Accordingly, the present invention is directed to a system for power management and safety protection using an ultrasonic sensor in both the power management and the safety protection recognition and a method thereof.

The present invention provides a system for power management and safety protection, which is applicable to a computer system and at least includes a frequency controller and a sensor. The frequency controller may control the sensor to send a low-frequency signal or a high-frequency signal. When the electronic device is in an operating mode, the frequency controller controls the ultrasonic sensor to send the low-frequency ultrasonic signal, so as to detect position information of a user relative to the computer system, thereby enabling the computer system to enter a sleep mode from the operating mode or enter a recognition mode from the sleep mode. When the computer system enters the recognition mode from the sleep mode, the frequency controller controls the sensor to send the high-frequency signal, the sensor detects motion information of the user, and the motion information is compared with a preset motion password, thereby enabling the computer system to return to the operating mode.

The present invention provides a method for power management and safety protection, which includes the following steps:

performing an operating mode by a computer system;

continuously sending a low-frequency ultrasonic signal by a sensor;

obtaining departure position information by the sensor;

commanding the computer system to perform a sleep mode;

obtaining approach position information by the sensor;

commanding the computer system to perform a recognition mode;

continuously sending a high-frequency ultrasonic signal by the sensor;

obtaining a motion message by the sensor;

determining whether the motion message is identical to a preset motion password; and

returning to the operating mode if the motion message is identical to the motion password.

In the system for power management and safety protection and the method thereof provided in the present invention, a sensor may be used as a trigger mechanism of power management and a recognition mechanism of safety protection at the same time, thereby achieving a more real-time trigger mechanism of power management and an easier recognition mechanism of safety protection. Meanwhile, the sensor may send a low-frequency signal or a high-frequency signal according to requirements of the power management and the safety protection, thereby managing the power consumption more effectively and ensuring the correctness of the recognition mechanism.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an exemplary application of the present invention;

FIG. 2 is a schematic block diagram of a system of the present invention; and

FIG. 3 is a flow chart of processes of the present invention.

### DETAILED DESCRIPTION OF THE INVENTION

The system for power management and safety protection and the method thereof provided in the present invention are applicable to a computer system. The computer system may be a desk-top computer, a notebook, or another computer system. The computer system mainly includes a hardware part, such as a mainboard, a central processing unit, and a memory; and a software part such as a basic input output system, an operating system, and application programs. In the following implementation, illustration is given by taking the notebook as an example.

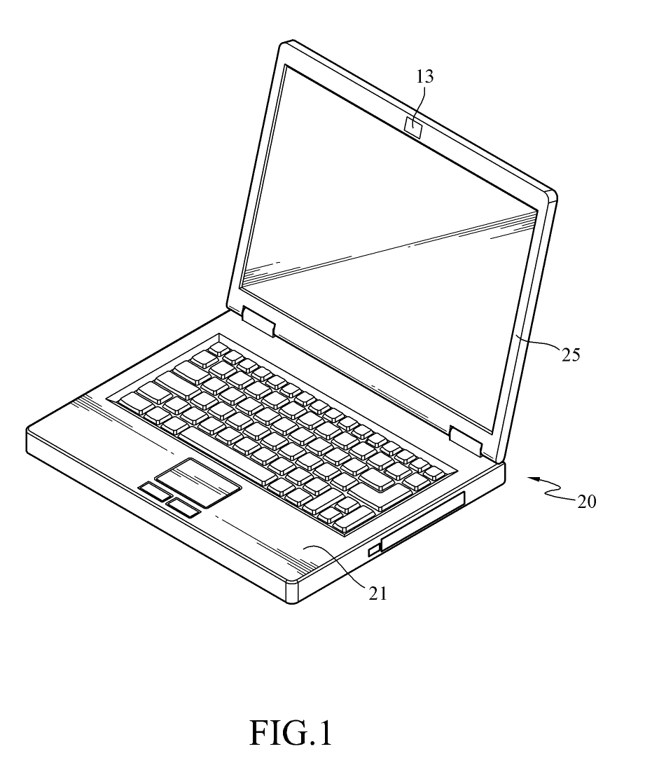

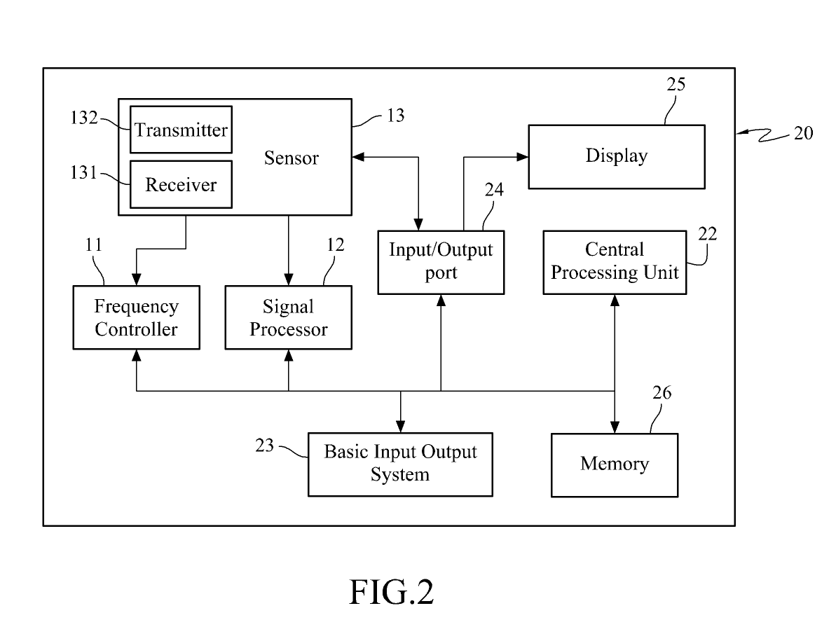

Referring to FIGS. 1 and 2, the system for power management and safety protection and the method thereof provided in the present invention are applicable to a computer system. The computer system is, for example, a notebook computer system 20. The notebook computer system 20 includes a host 21 and a display 25 in appearance. A sensor 13 is disposed at a proper position on the display 25. The sensor 13 may be an ultrasonic sensor or an infrared sensor for sending and receiving ultrasonic signals or infrared signals. The ultrasonic sensor is used as an embodiment of the present invention.

The notebook computer system 20 includes a central processing unit 22, a basic input output system 23, an input/output port 24, the display 25, and a memory 26. The constitutive architecture of the notebook computer system belongs to the prior art, and thus detail components and relations thereof will not be described in detail. A power management procedure and a safety protection procedure (not shown) are set in the basic input output system 23. The power management procedure at least includes an operating mode, a sleep mode, and other power processing modes, and the safety protection procedure at least includes a recognition mode. In addition, a motion password (not shown) is pre-stored in the memory 26. The motion password is the number of a particular motion.

The system for power management and safety protection provided in the present invention is disposed in the notebook computer system 20 and includes a frequency controller 11 and a sensor 13. The frequency controller 11 is a microprocessor and electrically connected to the sensor 13. The sensor 13 includes a transmitter 131 and a receiver 132. The transmitter 131 may be controlled by the frequency controller 11 to generate a high-frequency signal (ultrasonic signal) or a low-frequency signal (ultrasonic signal). The high-frequency ultrasonic signal has a sharp directivity and a good resolution, and is used for precise measurement. The low-frequency ultrasonic signal has a wide directivity and is used for large-scale detection. After the receiver 132 receives the ultrasonic signal, a signal processor 12 performs the power management procedure or the safety protection procedure according to the sensing signal.

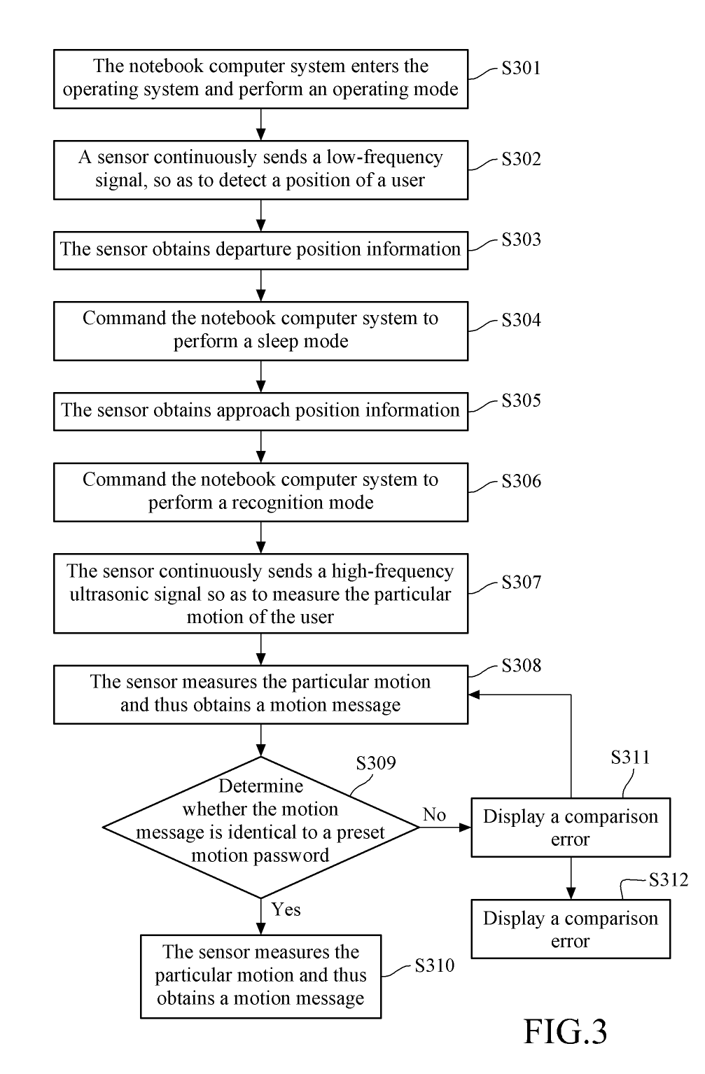

FIG. 3 shows the method for power management and safety protection according to the present invention. Referring to FIG. 3, when the notebook computer system 20 is powered on, the basic input output system 23 initializes all the hardware devices such as the frequency controller 11, the signal processor 12, and the sensor 13 included in the notebook computer system 20. After the initialization, the notebook computer system 20 enters the operating system and performs an operating mode (Step S301). At this point, the user executes relevant application programs in front of the notebook computer system 20. In the operating mode, the frequency controller 11 drives the sensor 13 to continuously send a low-frequency ultrasonic signal having a wide directivity so as to detect the position of the user in a large scale (Step S302). Meanwhile, the sensor 13 continuously receives a reflected signal, i.e., detects that the user still continuously operates in front of the notebook computer system 20. When the user departs, the sensor cannot receive the reflected signal. The sensor 13 thus obtains departure position information (Step S303). The sensor 13 transmits the departure position information to the signal processor 12, upon which the signal processor 12 sends a command to command the notebook computer system 20 to perform a sleep mode (Step S304). When the user comes back to the notebook computer system 20, the sensor 13 receives a reflected signal again and thus obtains approach position information (Step S305). The sensor 13 transmits the approach position information to the signal processor 12, upon which the signal processor 12 sends a command to command the notebook computer system 20 to perform a recognition mode (Step S306). In the recognition mode, the frequency controller 11 drives the sensor 13 to continuously send a high-frequency ultrasonic signal having a narrow directivity so as to perform a precise measurement. At this point, the user may be in front of the notebook computer system 20 and performs a particular motion such as waving a hand back and forth for several times toward the sensor 13 (Step S307). The sensor 13 measures the particular motion and thus obtains a motion message (Step S308). The motion message is the number of the particular motion. The motion message is further transmitted to the signal processor 12, and the signal processor 12 obtains the motion password from the memory 26 so as to determine whether the motion message is identical to a preset motion password (Step S309). If the motion message is identical to the motion password, the notebook computer system 20 returns to the operating mode (Step S310). If the motion message is different from the motion password, the notebook computer system 20 displays a comparison error (Step S311). Thus, a prompt window is displayed on the display 25, saying “Input Error, Please Try Again”, and the user can again perform the particular motion of waving the hand back and forth for several times toward the sensor 13. A limit value for the number of the comparison error is set in the recognition mode. If the number of the comparison error exceeds the limit value, the notebook computer system 20 ends the recognition mode (Step S312).

During the practical application, the sensor 13 may send the low-frequency ultrasonic signal according to the operating mode, so as to detect in a large scale whether the user is in front of the notebook computer system 20, or send the high-frequency ultrasonic signal according to the recognition mode so as to control the directional scale and precisely measure the particular motion of the user. Therefore, the integration of power management and safety protection by a sensor 13 is achieved, and the power-saving function and safety monitoring are thus surely achieved.

What is claimed is:

1. A method for power management and safety protection, applicable to an electronic device, comprising:
performing an operating mode by the electronic device;
continuously sending a low-frequency signal by a sensor, so as to detect a position of a user;
obtaining departure position information by the sensor, so as to command the electronic device to perform a sleep mode;
obtaining approach position information by the sensor, so as to command the electronic device to perform a recognition mode;
continuously sending a high-frequency signal by the sensor, so as to measure a particular motion of the user;
obtaining a motion message by the sensor;
determining whether the motion message is identical to a preset motion password; and
returning to the operating mode if the motion message is identical to the motion password.

2. The method for power management and safety protection according to claim 1, further comprising:
displaying a comparison error if the motion message is not identical to the motion password, after the step of determining whether the motion message is identical to a preset motion password in the recognition mode.

3. The method for power management and safety protection according to claim 2, further comprising: setting a limit value for the number of the comparison error, and ending the recognition mode if the number of the comparison error exceeds the limit value.

4. A system for power management and safety protection, applicable to an electronic device, the electronic device being set with at least an operating mode, a sleep mode, and a recognition mode, the system comprising:
a sensor; and
a frequency controller, electrically connected to the sensor, for controlling the sensor to send a low-frequency signal or a high-frequency signal;
wherein when the electronic device is in the operating mode, the frequency controller controls the sensor to send the low-frequency signal, so as to detect departure position information and approach position information of a user relative to the electronic device, thereby commanding the electronic device to enter the sleep mode or the recognition mode; and
when the electronic device is in the recognition mode, the frequency controller controls the sensor to send the high-frequency signal, so as to measure motion information of the user, thereby commanding the electronic device to return to the operating mode from the sleep mode.

5. The system for power management and safety protection according to claim 4, wherein the sensor comprises a transmitter, a receiver, and a signal processor, the signal processor is adapted to command the electronic device to perform the operating mode, the sleep mode, or the recognition mode.
